(19) United States
(12) Patent Application Publication
(10) Pub. No.: US 2025/0030008 A1
(43) Pub. Date: Jan. 23, 2025

(54) Carbon Supported Electrodes

(71) Applicant: The Lubrizol Corporation, Wickliffe, OH (US)

(72) Inventors: Thomas S. Corrigan, Lakewood, OH (US); Tyler Petek, Willowick, OH (US)

(73) Assignee: The Lubrizol Corporation, Wickliffe, OH (US)

(21) Appl. No.: 18/711,300

(22) PCT Filed: Nov. 17, 2022
(86) PCT No.: PCT/US2022/050224

§ 371 Date: May 17, 2024

Related U.S. Application Data
(60) Provisional application No. 63/281,118, filed on Nov. 19, 2021.

(51) Int. Cl. H01M 4/86; H01M 4/90; H01M 4/92; H01M 4/96

(52) U.S. Cl. CPC H01M 4/8652; H01M 4/8668; H01M 4/9083; H01M 4/921; H01M 4/96

(57) ABSTRACT

The disclosed technology relates to a composition for mitigating the corrosion of the carbon support in the catalyst layer of a membrane electrode assembly by including within a layer of the membrane electrode assembly a reversible organic inhibitor.

### BACKGROUND OF THE INVENTION

The disclosed technology relates to a composition for mitigating the corrosion of the carbon support in the catalyst layer of a membrane electrode assembly by including within a layer of the membrane electrode assembly a reversible organic inhibitor.

Proton exchange membrane fuel cells (PEMFCs) are a promising technology to enable the diversification of drivetrains for heavy duty vehicle applications and provide clean fuel alternatives to traditional combustion engines. Catalyst degradation is one of the main factors limiting the fuel cells from reaching their ultimate targets of 8,000 hrs operating time (150,000 miles) for light-duty vehicles or 25,000 hrs (1,000,000 miles) for heavy-duty vehicles with less than 10% performance loss as set by the Department of Energy (DOE).

Fuel cell catalyst layers (whether PEMFC, AFC, DMFC/DEFC) are known to degrade through corrosion of the carbon support within the layer. Carbon supports are high area electrically conductive materials which act as mechanical support for the active catalyst and also provide the electric conductivity for the transport of electrons. Carbon corrosion in the catalyst leads to destruction of catalyst connectivity, collapse of electrode pore structure, loss of hydrophobic character, and, in the case of Pt containing catalysts, increase in Pt particle size, all which negatively affect the efficiency of the fuel cell system.

The main mechanism by which carbon supports degrade in a PEMFC is the electrochemical oxidation (C+2H₂O→CO₂+4H⁺+4e-). This oxidation reaction begins to occur at 0.207 V vs RHE (“reversible hydrogen electrode” measured, for the purposes herein, at 0.1 molar concentration free protons in an aqueous based electrolyte). However, when localized regions are temporarily starved of hydrogen (a.k.a “fuel starvation”) or when hydrogen-oxygen (or air) gas fronts move through a cell (frequently encountered during startup and shutdown) it leads to an interfacial potential of up to 1.44V vs. RHE or above where the rate of the carbon oxidation reaction is sufficient enough to consume all of the carbon support within a matter of hours or less.

During a startup-shutdown event, when a hydrogen-oxygen gas front can move through what is the anodic side of the cell during normal operation, a “reverse current mechanism” can ensue in which the cathode, during normal operation, experiences an oxidizing potential. During this period of high electrode potential on what is normally the cathode, carbon on the cathode can corrode while protons are shuttled towards the anode, opposite to a normal fuel cell operating current flow. Once the hydrogen fuel reaches a state of continuity across the anode, the current and ion fluxes return to the normal mechanisms, and the cathode operates normally (i.e. electrochemically reducing oxygen).

During a hydrogen fuel starvation event, when there is still oxygen on what is normally the cathode side of the cell but the hydrogen supply to what is normally the anodic side of the cell is insufficient, the anode potential may increase until sufficient potentials are achieved to corrode carbon at appreciable rates.

A number of materials and engineering mitigation strategies to extend the durability of carbon supports have been investigated or implemented such as the use of highly graphitized carbons, however, their lower platinum utilization has prohibited widespread use. Other investigated strategies include voltage limitations and stack shunts through optimization of cathode outlet size.

None of the above have proven to be sufficient solutions to mitigating carbon corrosion, especially during startup and shutdown periods of operation.

In addition to catalyst degradation, membrane degradation is another significant factor limiting fuel cells from reaching their ultimate targets as set by the Department of Energy (DOE).

Lifetime requirements and high demand placed on PEMFCs leads to premature failure of the polymer electrolyte membrane (PEM), a critical PEMFC component. Over time, free radical species and peroxides produced during normal operation of PEMFCs chemically react with the PEM, compromising system performance by decreasing mechanical integrity and proton conductivity.

Current strategies to address this issue utilize some combination of the use of end group fluorination of perfluorosulfonic acid (PFSA) polymers and suspended metallic antioxidants (Ce or Mn). Unfortunately, unbound metallic antioxidants cause an undesirable decrease in proton conductivity and leach into other layers of the fuel cell, exposing the membrane to chemical degradation and poisoning of catalysts. These same issues can occur in anion exchange membranes. An alternative strategy seeks to immobilize antioxidants by covalently binding them to the polymers used as ion exchange membranes, but this approach requires chemical transformations, often involving additional linking groups. Furthermore, by altering the polymer from which the ion-exchange membrane is cast, such an approach alters the mechanical and electrical properties of the resulting membrane. Finally, while the incorporation of some antioxidants into PEMFCs can harm the proton conductivity and voltage produced by said PEMFCs, the current approaches fail to identify a criterion by which antioxidants with desirable and undesirable properties may be distinguished.

Thus, there is a need for a new strategy to extend the durability of carbon supports in fuel cell electrodes and to prolong PEM lifetime against chemical degradation.

### SUMMARY OF THE INVENTION

The disclosed technology solves the problem of carbon support degradation in an electrode and membrane chemical degradation by employing redox active molecules within at least one layer of the membrane electrode assembly composition.

Thus, the technology provides, in one aspect, a composition including a carbonaceous compound and a reversible organic inhibitor. The composition may be that of the fuel cell carbon support layer, microporous layer, or catalyst layer.

As the catalyst layer, the composition can further include a catalyst, as well as an ionomer and optional non-ionically conductive material.

In an embodiment, the reversible inhibitor is immobilized on the carbonaceous compound or in the membrane layer.

In another aspect of the invention, the technology encompasses a composition including an ionomer and a reversible organic inhibitor. In an embodiment, the reversible organic inhibitor can be immobilized onto the ionomer.

The ionomer composition may be mixed with a carbonaceous compound, catalyst, and optional non-ionically conductive material to prepare a catalyst layer for a fuel cell.

Any of the compositions can also be delivered as an “ink” diluted in a solvent in order to allow the compositions to be coated into place.

Also encompassed by the instant technology is a catalyst coated membrane (“CCM”) including (i) an electrolyte membrane, and (ii) a catalyst layer including a reversible organic inhibitor.

Another aspect of the instant technology is a gas diffusion layer (“GDL”) for a fuel cell having (iii) a microporous layer, and (iv) a carbon substrate, wherein either or both of layers include a reversible organic inhibitor.

A further aspect of the technology includes a gas diffusion electrode (“GDE”) for a fuel cell having (ii) a catalyst layer, (iii) a microporous layer, and (iv) a carbon substrate, wherein at least one of the layers has a reversible organic inhibitor.

A still further aspect of the technology is a fuel cell with a reversible inhibitor in (i) an electrolyte membrane, (ii) a catalyst layer, (iii) any other layer in electrical contact with the catalyst layer including but not limited to a microporous layer, and (iv) a carbon substrate, wherein at least one layer includes a reversible organic inhibitor.

The technology also encompasses a method of preventing corrosion to a carbonaceous compound in a catalyst layer of a fuel cell, by including in at least one layer of the fuel cell a reversible organic inhibitor, and operating the fuel cell.

The technology also encompasses a method of preventing degradation of the membrane of a fuel cell by chemical attack of oxidizing agents such as hydrogen peroxide or radical species, by including in at least one layer of the fuel cell a reversible organic inhibitor, and operating the fuel cell.

Both electrochemical carbon corrosion and membrane chemical oxidation events described above will henceforth be referred to as “oxidative degradation events”.

The disclosed technology provides a composition and method for mitigating the corrosion of the carbon support in the catalyst layer of a membrane electrode assembly and for mitigating the degradation of the membrane layer by including within a layer of the membrane electrode assembly a reversible organic inhibitor, allowing for improved fuel cells.

### BRIEF DESCRIPTION OF THE FIGURES

FIG. 1: CV of 3,4-dihydroxybenzoic acid in a fuel cell cathode

### DETAILED DESCRIPTION OF THE INVENTION

Various preferred features and embodiments will be described below by way of non-limiting illustration.

Unless otherwise stated, all part levels of the ingredients of are based on 100 parts by weight of the carbonaceous compound, the membrane ionomer, or a combination thereof as determined by the context of the disclosure abbreviated as “phr.”

Fuel cell membrane electrode assemblies (MEAs) generally contain several layers, including, but not limited to, carbon substrate layers, microporous layers, and catalyst layers, all surrounding the membrane layer. When used herein, the term “MEA” means an assembly including an ionically conductive polymer membrane layer surrounded by catalyst layers, in turn surrounded microporous layers, and finally surrounded by carbon substrate layers.

“Microporous layers” may also be referenced as “MPL”s herein and are a porous layer containing carbon and polymer (generally PTFE) coated directly onto a carbon substrate.

The “carbon substrate” is a layer that helps to support the MEA.

A combination of carbon substrate and MPL is referred to herein as a “Gas Diffusion Layer,” or “GDL.”

The catalyst layer can either be coated onto the carbon substrate, or a GDL where an MPL is employed, or onto the membrane layer. When the catalyst layer is coated onto a carbon substrate or GDL, it is referred to herein as the “Gas Diffusion Electrode,” or “GDE.” When the catalyst layer is coated onto the membrane, it is referred to herein as a “Catalyst Coated Membrane,” or “CCM.”

The membrane layer consists of a solid ion conducting medium, often polymeric in nature, serving multiple functions including transport of ions and separation of anode and cathode.

All of the foregoing nomenclature is common to the art and to the literature and will be well known by those of ordinary skill in the art.

Each of the carbon substrate layers, microporous layers, and catalyst layers contain an electrically conductive carbonaceous compound, also referred simply to as a carbonaceous compound. Because each of the layers is sandwiched together and touching, the carbonaceous compound can conduct electricity throughout all of the layers of the GDE on a respective side of the membrane.

Carbonaceous compounds can include, for example, electrically conductive carbon black, such as, for example, “acetylene black” or a “furnace black,” or any commercial grade of conducting carbon black, the acetylene blacks being superior in producing conducting blends.

Graphite is also a well-known carbonaceous compound and may be employed in the present technology in any of its various forms, including natural or synthetic, crystalline or amorphous, so long as the graphite is electrically conductive.

The carbonaceous compounds can also include electrically conductive carbon fibers, fullerenes, carbon nanotubes.

The type of carbonaceous compound will vary depending on the layer within which the support material is contained, for example, whether the carbonaceous compound is part of the carbon substrate or a host for the catalyst.

The carbon substrate for example can include carbonaceous compound that is in the form of a woven carbon fiber, carbon fiber mat, or carbon felt, which can include, for example Toray carbon paper, Freudenberg carbon paper, and SGL carbon paper from Sigracet. The carbon substrate can be prepared with the reversible organic inhibitor as an integral component, or the carbon substrate can be purchased commercially and the reversible organic inhibitor coated thereon, as will be discussed further below.

The microporous layer, by contrast to the carbon substrate, can include carbonaceous compound that is a high surface area and/or graphitic carbon. The MPL also contains non-carbonaceous material, which can include PTFE or other additives with individual component ranges of 2 to 200 phr. The microporous layer can be prepared with the reversible organic inhibitor as an integral component, or the microporous layer can be purchased commercially and the reversible organic inhibitor coated thereon, as will be discussed further below.

The catalyst layer can include, for example, carbonaceous compound that is also a high surface area carbon, which can include, for example carbon black materials, such as Vulcan carbon black or Ketjen black. Here again, the catalyst layer can be prepared with the reversible organic inhibitor as an integral component, or the catalyst layer can be purchased commercially and the reversible organic inhibitor coated thereon, as will be discussed furthe below.

The reversible redox inhibitor may be incorporated into the membrane layer by any means including but not limited to addition to the ionomer dispersion prior to membrane casting or absorption into pre-fabricated membrane. The additive may be non covalent or chemically bound to the membrane ionomer via synthetic modification resulting in ionic or covalent interaction.

The present technology provides a composition enabling an improved carbon supported electrode or polymer electrolyte membrane by introducing into the carbonaceous compound or any of the MEA layers a reversible organic inhibitor that acts as a sacrificial material that oxidizes to prevent fuel cell oxidative degradation events. The oxidation of the reversible organic inhibitor may be driven by an electric field or a chemical reaction with an oxidizing agent.

The reversible organic inhibitor is a compound that can mitigate carbon corrosion based on its reversible electrochemical redox potential. The reversible electrochemical redox potential of the inhibitor allows it to be oxidized at a potential below that which carbon oxidation becomes significantly detrimental (i.e. 1.2 V vs RHE) but above the practical operating potential of the fuel cell electrodes under normal operating conditions (e.g. −0.2 to 1.0 V vs RHE). When the reversible organic inhibitor is in electrical contact with carbonaceous compound in the cathode catalyst layer, and the localized interfacial potential reaches a value that matches or exceeds the oxidation potential of the reversible organic inhibitor (generally during startup/shutdown of the fuel cell or fuel starvation events), the reversible organic inhibitor will be oxidized in preference to the carbonaceous compounds, thereby preserving the integrity of the catalyst layer.

The reversible organic inhibitor is a compound that can mitigate detrimental oxidation of the membrane material by chemical oxidizing agents, e.g., oxidative attack by peroxide radicals which can be formed during operation, particularly during operation at low overpotentials (i.e., near open circuit). When the chemical oxidizing agents are formed, the reversible organic inhibitor can be chemically oxidized instead of the membrane material.

In other words, during oxidation events the reversible organic inhibitor will be oxidized into redox active species instead of the detrimental oxidation of the carbonaceous compounds or the membrane material.

The reversible organic inhibitor can have a redox potential in the range of 0.5 to 1.4 V vs RHE while in aqueous environments. Examples of reversible organic inhibitors are compounds having a redox potential in the range of 0.6 to 1.3 V vs. RHE, or even 0.7 or 0.8 to 1.2 V vs. RHE in an aqueous environment.

The reversible organic inhibitor must also not poison the active catalyst, i.e., it must not reduce the activity of the catalyst towards oxygen reduction to detrimental effect.

The oxidation of the reversible organic inhibitor (chemical or electrochemical) must also have facile kinetics such that the oxidation of the molecule occurs at appreciable rates before the fuel cell oxidation events (carbon corrosion or membrane) (i.e. is not limited by overpotentials) and its subsequent reduction to the original state occurs before further subsequent oxidations are required. Upon return to normal operation, and return to normal current flow and electrode potentials, the redox active species will then be reduced back to its state prior to the oxidation event, regenerating the protective reversible organic inhibitor to be oxidized again during subsequent oxidation events.

Additionally, the reversible organic inhibitor must come in contact with the electrically conductive carbon material in order to be electrochemically reduced and regenerate the protective state of the reversible redox inhibitor. To be clear, the reversible inhibitor can be included with the carbonaceous compound in any of the carbon containing layers, i.e., carbon substrate layers, microporous layers, and/or catalyst layers or membrane. Further, each layer can contain one or a mixture of two or more reversible organic inhibitors.

Examples of currently known reversible organic inhibitors meeting the foregoing criteria include many hydroquinones/quinones, such as, for example, potassium 1,4-hydroquinonesulfonate; methyl 2,5-dihydroxybenzoate; 2,5-dihydroxybenzoic acid; 2,5-dihydroxybenzoic acid; 2,5-dimethoxybenzonitrile; 3,6-dihydroxyphthalonitrile; 3,4-dihydroxybenzoic acid; 2,3-Dichloro-5,6-dicyano-1,4-benzoquinone.

One of ordinary skill in the art will readily be able to test for compounds that constitute reversible organic inhibitors based on the foregoing criteria according to the techniques described herein. All such reversible organic inhibitors are contemplated under the present disclosure.

One method to evaluate the redox potential is to first prepare an ink containing a mixture of carbon or platinum on carbon, a proton conducting ionomer such as a perfluorosulfonic acid ionomer, the reversible redox inhibitor, and a carrier solvent such as water and isopropanol. This ink is homogenized using a technique such as high sheer mixing, ultrasonication, or ball milling. The resultant ink is then deposited onto a carbon electrode and the carrier solvent is allowed to evaporate. The recipe and formation of these inks and subsequently formed electrode is described in detail in the generally known art. The resulting electrode may then be used in a three-electrode cell and cycled through various potential windows in an acidic aqueous electrolyte via traditional electrochemical techniques such as cyclic voltammetry to obtain redox profiles. The cyclic voltammogram, along with other electrochemical techniques, such as electrochemical impedance spectroscopy, may also be used to infer the kinetic rate at which the redox event occurs. From these cyclic voltammetry experiments, the redox activity of each molecule was observed at 100 mV/s and run between-0.28 and 1.0 V vs Ag/AgCl. The measured potential for a coupled reduction and oxidation reaction, described as the E° of the molecule, is calculated as the average of the peak oxidation and the peak reduction currents observed during cyclic voltammetry conducted at 100 mV/s scan rates during the third cycle.

In one embodiment, the technology provides a composition containing a carbonaceous compound and a reversible organic inhibitor. The carbonaceous compound and the reversible organic inhibitor may be simply mixed together and in physical contact, or the reversible organic inhibitor may be immobilized onto the carbonaceous compound. Immobilization may be, for example, by covalent bonding of the reversible organic inhibitor to the carbonaceous compound by methods known in the art for covalently bonding organic compositions to carbon compositions. Such covalent bonding techniques include, for example carbon functionalization via grafting of aryl radicals formed from the decomposition of aryl diazonium salts or aryl iodonium salts. Another option is pre-functionalization of the carbonaceous material via incorporation of oxygen, nitrogen, sulfur, or other atoms via an oxidation process, and further covalent bond forming reaction of the oxidized carbonaceous material and the reversible inhibitor.

The amount of reversible organic inhibitor, when present in a particular layer, can range from 1 phr to 50 phr based on the total carbon content of the particular layer at hand, or from 2 phr to 40 phr based on the total carbon content of the particular layer at hand, or even from 3 phr to 37 phr based on the total carbon content of the particular layer at hand or from 4 phr to 35 phr based on the total carbon content of the particular layer at hand, or even 5 phr to 34 phr based on the total carbon content of the particular layer at hand.

Each of the MEA layers needs in some manner to be deposited to form a layer. In order to allow the layers to be of a consistency to allow coating, a solvent is added to the mixture of the carbonaceous compound and reversible organic inhibitor to obtain an “ink.” In a simplest embodiment, the layers can be deposited as an “ink,” which is used herein to mean the flowable precursor to the final deposited layer dependent upon the coating technology employed. The inks can contain all the components of the electrode. For example, the inks can contain the carbonaceous compound, an ionomer, an additional type of binder (e.g. polymeric material reversible organic inhibitor, and a solvent. This ink is deposited and the solvent is allowed to evaporate, leaving behind the chosen layer of carbonaceous compound, ionomer, and organic inhibitor.

For example, as discussed above, the microporous layer may be coated onto the carbon substrate layer. An MPL ink is coated onto the carbon substrate and the solvent is allowed to evaporate, leaving the MPL carbonaceous compound and inhibitor behind.

As with the MPL, the catalyst layer can be applied as an ink. Here again, the ink can be coated onto the appropriate substrate (e.g., either the GDL or the membrane) and the solvent allowed to evaporate, leaving the catalyst layer behind.

Solvents suitable for use in the “ink” can include, for example any combination of 1-propanol, 2-propanol, water, or other solvents suitable for dispersion of catalyst materials which is also amenable to the chosen coating method, which would be readily discernable to those of ordinary skill in the art.

Each layer can also include other additives. For instance, the MPL can include a binder, such as a PTFE, as already referenced.

The catalyst layer can also include a metal or non-metal catalyst on which the electrochemical reaction of the fuel cell is promoted. The metal catalyst can be a noble metal or transition metal or an alloy of any thereof. Examples of such metals include, for example, ruthenium, rhodium, palladium, osmium, iridium, platinum, gold, silver, copper, rhenium, mercury, iron, cobalt, and nickel. In an embodiment, the metal catalyst is a platinum or platinum alloy.

The catalyst layer can also include an ionomer polymer binder. The ionomer is a polymer that can transport protons (i.e., H+) to and from reaction sites within the fuel cell, and can help to disperse the electrode components. By “reaction sites” it is meant a site in the electrode layer where electrons (e.g., via an electrically conducting carbon), protons (e.g., via an ionically conductive polymer), and react gas can all be transported to and from the active catalyst. Any proton conducting polymer can be employed as the ionomer. An example of proton conducting polymers commonly employed as ionomers and suitable in the present invention are sulfonic acid polymers. Sulfonic acid polymers are widely discussed in the literature and are not particularly limited here. Examples of sulfonic acid polymers include any sulfonate ion exchange polymer, which is to say, polymers containing sulfonic acid moieties. Sulfonic acid polymers can include, but are not limited to, perfluorosulfonic acid polymers, sulfonated poly(benzimidazole) polymer, sulfonated poly(arylene ethers) polymers, sulfonated poly(ether ether ketone) polymer, sulfonated polyvinyl chloride, 2-acrylamido-2-methylpropane sulfonic acid (AMPS), and poly(styrene sulfonate) (block co) polymer, as examples, but the sulfonic acid could be any other sulfonic acid polymer now known or developed in the future. Other examples of ionomers can include sulfonated polybenzimidazole polymers, carboxylic acid polymers, phosphonic acid polymers, phosphoric acid doped polymers, and the like. The ionomer polymer binder is not limited and may be any proton conducting polymer now known or developed in the future.

The catalyst layer can also include a non-ionically conductive material to help maintain the integrity of the catalyst layer. Examples of non-ionically conductive materials can include polymers such as polyvinyl alcohol, polyacrylate, polymethacrylate, functionalized polyethylene oxides, functionalized polypropylene oxides; thermoplastic polyurethanes. Here again, the non-ionically conductive materials are not limited and may be any material now known or developed in the future to help maintain the integrity of the catalyst layer.

With respect to the catalyst in particular, there is an alternative embodiment to first preparing the carbonaceous compound and reversible organic inhibitor. In the alternative embodiment, the reversible organic inhibitor can be immobilized by functionalization onto the ionomer, followed by mixing the functionalized ionomer with the carbonaceous compound, catalyst, and optionally a non-ionically conductive material. The entire mixture may be mixed with the solvent to prepare the ink as well.

In one embodiment, the present technology provides an ionomer additive composition. The ionomer additive composition can include the ionomer, optional non-ionically conductive material, reversible organic inhibitor, and solvent.

The ionomer additive composition may be mixed with a catalyst-on-carbonaceous compound deposit composition to prepare a catalyst ink. With respect to the catalyst-on-carbonaceous compound deposit composition, often a reducing agent is employed to reduce an acidic solution of the catalyst onto the carbonaceous compound. However, it is well known in the art that catalysts can be deposited on carbonaceous compounds, and such deposition process is not within the scope of this technology, suffice to say any method to deposit the catalyst on the carbonaceous compound may be included herein.

The ionomer additive composition and catalyst-on-carbonaceous compound deposit composition can be mixed together to form a catalyst ink. Examples of mixing may be any combination of physical stirring, high shear mixing, sonication or any other type of mixing. The catalyst ink prepared would then contain (a) carbonaceous compound, (b) metal or non-metal catalyst, (c) reversible organic inhibitor, (d) ionomer, (e) optional non-ionically conductive material, all in (f) solvent. The concentrations of the foregoing components will depend on the concentrations desired in the final electrode, as set forth above. Generally, the catalyst can be present at about 5 to about 150 phr, or from about 20 to about 130 phr, or about 40 to about 110 phr, or even about 60 to about 90 phr.

An ink composition may consist of 40-99.9% solvent and 0.1-60% solids, where the solids are comprised of a mixture of catalyst on carbonaceous compound, ionomer, and reversible redox inhibitor. The carbonaceous material in the ink can range from 25-70 wt % of total solids in either catalyst containing inks or MPL inks. Ionically conducting polymers in the catalyst ink can range from 20-60 wt % total solids. Catalysts to perform ORR in the catalyst inks can range from 1-40 wt % total solids. Non-ionically conducting binder in the MPL inks can range from 20-70 wt % total solids. Polymeric additives, in addition to the non-ionically conducting material in the MPL or ionically conducting material in the catalyst inks, may range from 0-25 wt % total solids in either the MPL or the catalyst inks. Lastly, the reversible organic carbon corrosion inhibitor can exist in either the MPL or catalyst inks ranging from 1-25 wt % total solids.

The carbon supported electrode can be prepared from the catalyst ink by known methods, such as, for example, known coating or printing techniques, such as spray coating, decal coating, screen printing, ink jet printing or other methods such as rollto-roll transfer, doctor blade, colander rolling, or any other known method.

Also encompassed in the present technology is a fuel cell including an electrolyte membrane interposed, or sandwiched, between two catalyst layers to form a catalyst coated membrane (or CCM), where the two catalyst layers act as anode and cathode during operation of the fuel cell. The fuel cell can further include the CCM interposed, or again, sandwich between two gas diffusion (or GDL) layers, the GDL layers each including a microporous layer coated onto a carbon substrate.

The present technology also allows for a method of preventing corrosion of carbon in a carbon supported catalyst layer within a fuel cell, by including in at least one of the carbon containing layers of the fuel cell a reversible organic inhibitor, and operating the fuel cell.

The disclosed technology, solves the problem of carbon support degradation in an electrode by employing redox active molecules within at least one layer of the membrane electrode assembly composition.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLES

As described above, the redox potential and activity of candidate molecules were measured by including the molecules in an electrode ink which was then tested on a rotating disc electrode in a three-electrode cell configuration similar to those found in the published literature. The ink utilized for these tests to specifically probe the redox activity was composed of 7.6 mg XC-72 carbon, 40 μL of Nafion D2020 solution, 2.6 mL isopropanol, and 7.4 mL deionized water with 1.5 mg of the molecule being tested. These inks were dispersed by sonication for 16 minutes in an ice bath. After sonication, 10 μL of the resulting ink was deposited onto the tip of a 0.196 cm² glassy carbon electrode from Pine Research. The glassy carbon electrode was polished with 0.05 μm alumina polishing media and dried under nitrogen prior to the ink deposition. After the ink was deposited on the surface of the glassy carbon electrode, the ink was dried by rotating the electrode at 700 RPM. Once the ink was dry, the electrode was submerged in a glass cell filled with 0.1 molar perchloric acid in deionized water. Nitrogen gas was bubbled into the solution for 30 minutes while the glass carbon electrode with the dried ink was rotated at 1600 RPM. Subsequently, the nitrogen gas supply was altered such that it was supplying nitrogen to the headspace in the cell. In this three-electrode cell configuration, the counter electrode is a platinum wire coil supplied by Pine Research and the reference electrode is a Ag/AgCl electrode equilibrated in 3 molar sodium chloride provided by BASi. The reference electrode was placed in a fritted reservoir which has the frit in the main solution volume and the reservoir is filled with 0.1 M perchloric acid. The subsequent electrochemical tests were performed with the active nitrogen blanket and with the glassy carbon electrode rotating at 1600 PRM.

Multiple cyclic voltammetry tests were conducted on each of the inks over a potential range of −0.28 to +1.0 volts vs the Ag/AgCl electrode. Each cyclic voltammetry test was IR-corrected to 90% of the real impedance measured at 60-90 kHz. From these cyclic voltammetry experiments, the redox activity of each molecule was observed at 100 mV/s. The table below shows a measured potential for a coupled reduction and oxidation reaction, described as the E° of the molecule, calculated as the average of the peak currents observed during cyclic voltammetry conducted at 100 mV/s scan rates during the third cycle. The E° values reported in the following table are for the observed redox couples of interest from these experiments. Only one of the E° values are reported in the table below, but there may be other redox couples not reported here for each molecule, for example, if the redox couple had a relatively small peak current (indicating lower activity) or was outside the window of interest for these applications. The potentials reported in the table are versus the reversible hydrogen electrode potential. For these purposes, it is assumed that the Ag/AgCl reference electrode is +0.28 V positive of the RHE electrode.

TABLE 1

| Molecule | Structure | Eº vs RHE |
|---|---|---|
| 2,5-dihydroxyterephthalic acid | 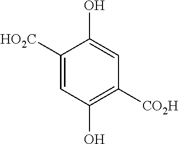 [SMILES: O=C(O)c1cc(O)c(C(=O)O)cc1O] | 0.45 |
| 2,5-di-tert-buty-1,4-hydroquinone | 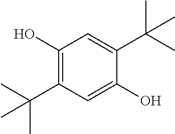 [SMILES: CC(C)(C)c1cc(O)c(C(C)(C)C)cc1O] | 0.48 |
| 2,5-di-tert-butyl- 1,4-dimethoxybenzene | 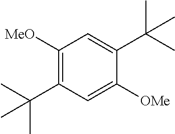 [SMILES: COc1cc(C(C)(C)C)c(OC)cc1C(C)(C)C] | 0.50 |
| 3-amino-4-hydroxy-benzene sulfonic acid | 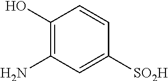 | 0.61 |
| N-phenyl-1-naphthylamine (PANA) | 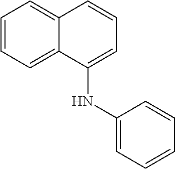 [SMILES: c1ccc(Nc2cccc3ccccc23)cc1] | 0.61 |
| 2,5-dihydroxybenzoic acid | 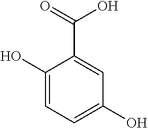 [SMILES: O=C(O)c1cc(O)ccc1O] | 0.64 |
| 2,4-di-tert-butyl-3-hydroxybenzene sulfonic acid | 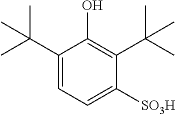 [SMILES: CC(C)(C)c1ccc(S(=O)(=O)O)c(C(C)(C)C)c1O] | 0.68 |
| Potassium 1,4-hydroquinone sulfonate | 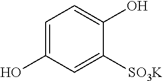 | 0.80 |
| 2,5-dimethoxybenzonitrile | 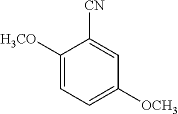 [SMILES: COc1ccc(OC)c(C#N)c1] | 0.84 |
| methyl 2,5-dihydroxybenzoate | 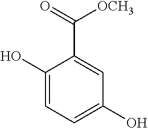 [SMILES: COC(=O)c1cc(O)ccc1O] | 0.84 |
| 3,4,5-trihydroxybenzoic acid | | 0.85 |
| Caffeic Acid | 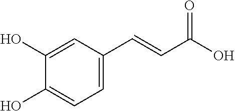 [SMILES: O=C(O)/C=C/c1ccc(O)c(O)c1] | 0.85 |
| 1,2-dihydroxybenzene- 3,5-disulfonic acid sodium salt | 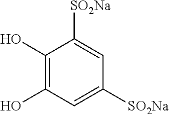 | 0.92 |
| 3,4-dihydroxybenzoic acid | 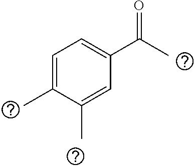 | 0.92 |
| 2,3-dichloro-5,6-dicyano- 1,4-benzoquinone (DDQ) | 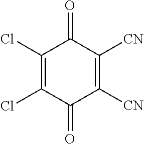 [SMILES: N#CC1=C(C#N)C(=O)C(Cl)=C(Cl)C1=O] | 0.95 |
| 2,3-dicyanohydroquinone | 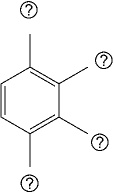 | 0.98 |

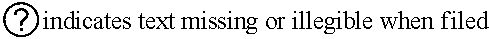

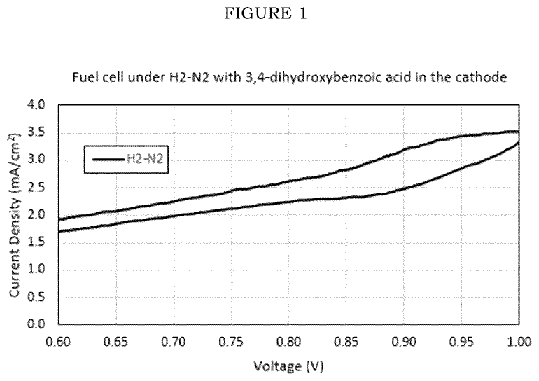

For those embodiments in which the reversible organic inhibitor was added to the catalyst layer, a catalyst ink was prepared from Pt/C fuel cell catalyst, ionomer, isopropanol, and water. Furthe, reversible organic inhibitor in the case of the cathode ink. The ink(s) were then coated onto gas diffusion substrates to prepare gas diffusion electrodes. A commercial ionomer membrane was then sandwiched between the anode and cathode gas diffusion electrodes with a hot-pressing process. When carbon only was used in place of Pt/C, the redox profile of the reversible organic inhibitor could be clearly seen in the fuel cell CV. FIG. 1 shows the observed rebversible redox potential for 3,4-dihydroxybenzoic acid from the fuel cell assembly, which matches the redox potentials as measured using the RDE bench tests as done in the examples above. The redox potentials for 3,4-dihydroxybenzoic acid from the fuel cell assembly are also represented in Table 1 below. This data confirms that the reversible organic inhibitor has a redox at or near the OCV in an operating fuel cell, and that it is able to cycle oxidation states in the fuel cell, suggesting the regenerative mechanism is possible. Further implications of the redox activity in the fuel cell is the ability to alter the operating potential of the cathode, with potential negative consequences if the redox potential of the reversible redox inhibitor is not near the OCV for oxygen reduction.

TABLE 2

| | | |
|---|---|---|
| 3,4-dihydroxybenzoic acid | 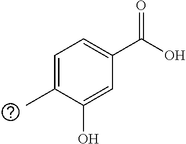 | 0.93 |

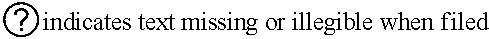

For those embodiments in which the reversible organic inhibitor was added to the fuel cell in the membrane layer, an ionomer was dispersed in a solution of isopropanol and water and the desired reversible organic inhibitor was added to this solution. The solution was then cast on a flat surface. The solvent was allowed to evaporate to leave behind a film with a thickness of 15-20 microns. In many embodiments, a 5-10 micron ePTFE layer was used to support the membrane.

Membrane electrode assemblies were fabricated from the casted membranes. Each membrane was placed between two protective gaskets, each measuring one mil, such that 50 square centimeters of the membrane (the “active area”) was exposed while the outside edges of the membrane were covered by the protective gasket. On one side of the membrane, the active area was placed in contact with an anode, while on the other side of the membrane, the active area was placed in contact with a cathode. Each electrode, in addition to contacting the entirety of the active area on its side of the membrane, also covered part of the protective gasket, overlapping by 1.85 mm. The remainder of the protective gasket was covered by a regular gasket. Each electrode was, in turn, covered by a gas diffusion layer that was bounded on its outside edges by the regular gasket. A platinum on carbon catalyst was present on both electrodes with a loading between 0.1 and 0.3 mg platinum per cubic centimeter.

The membrane electrode assembly made from each membrane was subjected to an open circuit voltage (OCV) accelerated stress test to measure the maximum operating voltage of the assembly in the absence of electrical current and the presence of a significant concentration of hydrogen peroxide and its radical degradation products. At 25° C., initial testing was performed to ensure that hydrogen crossover, OCV, and cyclic voltammetry (CV) readings were normal. Next, beginning-of-life (BOL) characterization was performed, measuring hydrogen crossover, CV, and VI at 95% relative humidity (RH), 150 kPa, and 80° C. with high frequency resistance (HFR)/electrochemical impedance spectroscopy (EIS). Then, beginning-of-test (BOT) measurements of hydrogen crossover, EIS at 0.2 A/cm², and OCV were performed. OCV conditions were 30% RH, 90° C., 150 kPa, and 700/1750 sccm H₂/air. After BOT characterization, a chemical degradation test was performed. OCV was measured at the same conditions as in the BOT, and EIS at 0.2 A/cm² was performed every 24 hours. Chemical degradation testing continued until a failure event such as pinhole formation, marked by a sudden drop in the OCV, occurred, or until the OCV read below 0.8 V. This testing was considered to be successful if the OCV was maintained for at least 500 hours, a benchmark defined by the Department of Energy. Next, end-of-test (EOT) characterization was performed. This testing included OCV, EIS, and hydrogen crossover at the same conditions as in BOT characterization. Finally, polarization curves after cycles and conditioning were obtained. Hydrogen crossover, CV, and VI were measured in the same manner as in BOL testing. The data reported in Table 3 correspond to membranes initially 15-20 μm thick. All of the membranes have a 5 μm thick ePTFE support.

The results of the OCV testing indicate that only membrane electrode assemblies comprising redox regenerative additives, those with redox potentials above 0.9 V, maintain their voltage for at least 500 hours.

TABLE 3

| | E° | |
|---|---|---|
| Molecule | V vs RHE | OCV Hours |
| Baseline (ePTFE supported | — | 180 h |
| PFSA, no additive) | | |
| Baseline (ePTFE supported | n.r. | 620 h |
| PFSA + Cerium | | |
| 2,4-di-tert-butyl-3-hydroxyben- | 0.68 | 16 |
| zenesulfonic acid | | |
| 3,4,5-trihydroxybenzoic acid | 0.85 | Starting OCV < |
| | | 0.8 V |
| Quercetin | 0.87 | 300 |
| 3,4-dihydroxybenzoic acid | 0.92 | >1000 |
| 2,3-dicyanohydroquinone | 0.98 | >1000 |

Effluent water collection was performed to analyze the contents of the wastewater emitted by the fuel cell. The addition of a reversible organic inhibitor, 3,4-dihydroxybenzoic acid, to the ionomer decreased the concentration of fluoride ion, a degradation product of perfluorinated ionomers, present in the effluent water.

3,4-DHBA

| time (h) | Sample F- ions (ppm) | OCV (V) |
|---|---|---|
| 72 | 0.13 | 0.83 |
| 72 | 0.11 | 0.83 |
| 120 | 0.09 | 0.84 |
| 168 | 0.08 | 0.83 |
| 240 | 0.07 | 0.87 |
| 288 | 0.07 | 0.82 |
| 408 | 0.07 | 0.88 |
| 456 | 0.08 | 0.87 |
| 504 | 0.08 | 0.84 |
| 576 | 0.08 | 0.87 |
| 624 | 0.07 | 0.87 |
| 672 | 0.07 | 0.86 |
| 744 | 0.07 | 0.86 |
| 792 | 0.07 | 0.86 |
| 840 | 0.08 | 0.86 |

Baseline (No additive)

| Time (h) | Sample F- ions (ppm) | OCV (V) |
|---|---|---|
| 0 | 0.08 | 0.50 |
| 48 | 0.02 | |
| 48 | 0.01 | 0.82 |
| 96 | 0.02 | 0.81 |
| 168 | 0.03 | 0.81 |
| 192 | 0.05 | 0.82 |
| 216 | 0.07 | 0.81 |
| 312 | 0.07 | 0.81 |
| 336 | 0.10 | 0.82 |
| 384 | 0.12 | 0.83 |
| 432 | 0.13 | 0.83 |
| 504 | 0.14 | 0.83 |
| 552 | 0.17 | 0.83 |

Except in the Example, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

A composition comprising (a) (i) carbonaceous compound, (a) (ii) ionomer, or (a) (iii) mixtures of (a) (i) and (a) (ii), and (b) a reversible organic inhibitor.

A composition comprising (a) ionomer, and (b) a reversible organic inhibitor.

A composition comprising (a) carbonaceous compound, and (b) a reversible organic inhibitor.

A composition comprising (a) carbonaceous compound, (b) a reversible organic inhibitor; and a solvent.

A composition comprising (a) a carbonaceous compound, and (b) a reversible organic inhibitor, and a porous binder.

A composition comprising (a) a carbonaceous compound, and (b) a reversible organic inhibitor, a porous binder; and a solvent.

A composition comprising (a) a carbonaceous compound, (b) reversible organic inhibitor, (c) catalyst, and (d) ionomer.

A composition comprising (a) a carbonaceous compound, (b) reversible organic inhibitor, (c) catalyst, (d) ionomer; and a solvent.

A composition comprising (a) a carbonaceous compound, (b) reversible organic inhibitor, (c) catalyst, (d) ionomer, and (e) non-ionically conductive material.

A composition comprising (a) a carbonaceous compound, (b) reversible organic inhibitor, (c) catalyst, (d) ionomer, (e) non-ionically conductive material; and a solvent.

A composition comprising an ionomer and a reversible organic inhibitor.

A composition comprising an ionomer, a reversible organic inhibitor, and a solvent.

The composition of the previous sentence wherein the reversible organic inhibitor is immobilized on the ionomer.

The composition of any previous sentence wherein the reversible organic inhibitor is immobilized on the carbonaceous compound.

A catalyst coated membrane (“CCM”) comprising (i) an electrolyte membrane, and (ii) a catalyst layer, wherein the catalyst layer comprises a carbonaceous compound and a reversible organic inhibitor.

A gas diffusion layer (“GDL”) comprising (iii) a microporous layer comprising a carbonaceous compound and a porous binder, and (iv) a carbon substrate, wherein either or both of elements (iii) and (iv) comprise a reversible organic inhibitor.

The GDL of the previous paragraph, wherein the microporous layer comprises the reversible organic inhibitor. The GDL of the previous paragraph, wherein the carbon substrate comprises the reversible organic inhibitor.

A gas diffusion electrode (“GDE”) comprising (ii) a catalyst layer comprising a carbonaceous compound, (iii) a microporous layer comprising a carbonaceous compound and a porous binder, and (iv) a carbon substrate, wherein at least one of elements (ii), (iii) and (iv) comprise a reversible organic inhibitor.

The GDE of the previous paragraph, wherein the catalyst layer comprises the reversible organic inhibitor. The GDE of the previous paragraph, wherein the microporous layer comprises the reversible organic inhibitor. The GDE of the previous paragraph, wherein the carbon substrate comprises the reversible organic inhibitor.

A fuel cell comprising (i) an electrolyte membrane, (ii) a catalyst layer, (iii) a microporous layer, and (iv) a carbon substrate, wherein at least one of elements (i), (ii), (iii) and (iv) comprise a reversible organic inhibitor.

A method of preventing corrosion to a carbonaceous compound in a catalyst layer of a fuel cell, comprising including in at least one layer of the fuel cell a reversible organic inhibitor, and operating the fuel cell.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A composition comprising a mixture of (a)(i) carbonaceous compound, (a)(ii) ion conducting polymer, and (b) a reversible organic inhibitor that is regenerated by electrochemical reduction and that has a reversible oxidation/reduction potential on a carbon electrode in the range of 0.5 to 1.4 V vs RHE.

2. (canceled)

3. The composition of claim 1, wherein the ionomer comprises a polymer comprising sulfonic acid moieties.

4. The composition of claim 1, wherein the ionomer comprises a perfluorosulfonic acid polymer.

5. The composition of claim 1, comprising from 0.2 to 25 mol %, relative to the sulfonic acid moieties of the ionomer, of the reversible organic inhibitor.

6. The composition of claim 1, comprising from 0.2 to 10 mol %, relative to the sulfonic acid moieties of the ionomer, of the reversible organic inhibitor.

7. (canceled)

8. The composition of claim 1, comprising from 1 to 50 phr, relative to the carbonaceous compound.

9. The composition of claim 1, comprising from 5 to 34 phr, relative to the carbonaceous compound

10. The composition of claim 1, further comprising a catalyst.

11. The composition of claim 1, further comprising a non-ionically conductive material.

12. The composition of claim 1, further comprising a solvent.

13. The composition of claim 1, wherein the catalyst comprises a noble metal.

14. The composition of claim 1, wherein the catalyst comprises platinum.

15. The composition of claim 1, wherein the catalyst comprises a transitional metal.

16. The composition of claim 1, wherein the catalyst comprises iron.

17. The composition of claim 1, wherein the catalyst comprises nickel.

18. The composition of claim 1, wherein the catalyst comprises an alloy of any of the foregoing.

19. The composition of claim 1, wherein the catalyst comprises a non-metallic catalyst.

20. (canceled)

21. The composition of claim 1 wherein the reversible organic inhibitor has a reversible oxidation/reduction potential on a carbon electrode in the range of 0.9 to 1.2 V vs RHE.

22. The composition of claim 1 wherein the reversible inhibitor comprises a hydroquinone or quinone.

23. The composition of claim 1, wherein the reversible organic inhibitor comprises 1,2-dihydroxybenzene-3,4-disulfonic acid sodium salt, 2,3-dichloro-5,6-dicyano-1,4-benzoquinone, 2,3-dicyanohydroquinone, or 3,4-dihydroxybenzoic acid.

24. (canceled)

25. (canceled)

26. (canceled)

27. (canceled)

28. (canceled)

29. A catalyst coated membrane (“CCM”) comprising (i) an electrolyte membrane, and (ii) a catalyst layer, wherein the catalyst layer comprises a carbonaceous compound and a reversible organic inhibitor.

30. A gas diffusion layer (“GDL”) comprising (iii) a microporous layer comprising a carbonaceous compound and a porous binder, and (iv) a carbon substrate, wherein either or both of elements (iii) and (iv) comprise a reversible organic inhibitor.

31. A gas diffusion electrode (“GDE”) comprising (ii) a catalyst layer comprising a carbonaceous compound, and at least one of: (iii) a microporous layer comprising a carbonaceous compound and a porous binder, and (iv) a carbon substrate; wherein at least one of elements (ii), (iii) and (iv) comprise a reversible organic inhibitor.

32. (canceled)

33. A method of preventing corrosion to a carbonaceous compound in a catalyst layer of a fuel cell, comprising including in at least one layer of the fuel cell a reversible organic inhibitor, and operating the fuel cell.

34. (canceled)
